(19) United States
(12) Patent Application Publication
(10) Pub. No.: US 2005/0069754 A1
(43) Pub. Date: Mar. 31, 2005

(54) Diffusion electrode for fuel cell

(76) Inventors: Ji-rae Kim, Seoul (KR); Kyoung-hwan Choi, Suwon-si (KR)

Correspondence Address: MCGUIREWOODS, LLP, 1750 TYSONS BLVD, SUITE 1800, MCLEAN, VA, 22102, US

(21) Appl. No.: 10/942,779

(22) Filed: Sep. 17, 2004

(30) Foreign Application Priority Data
Sep. 26, 2003 (KR) 2003-66941

(51) Int. Cl. H01M 4/86

(52) U.S. Cl. 429/42; 429/40

(57) ABSTRACT

A diffusion electrode for a fuel cell, having good polar liquid transporting property and gas transporting property, and an electrode and a fuel cell using the diffusion electrode are provided. The diffusion electrode includes: hydrophobic porous agglomerates containing electroconductive particles and a hydrophobic binder resin, wherein the hydrophobic porous agglomerates form a three dimensional netlike structure; and hydrophilic porous agglomerates containing electroconductive particles, wherein the hydrophilic porous agglomerates form a three dimensional netlike structure filling empty space among the three dimensional netlike structure formed by the hydrophobic porous agglomerates..

This application claims the benefit of Korean Patent Application No. 2003-66941, filed on Sep. 26, 2003, which is hereby incorporated by reference for all purposes as if fully set forth herein.

### BACKGROUND OF THE INVENTION

1. Field of the Invention

The present invention relates to a fuel cell, and more particularly, to a diffusion electrode for a fuel cell.

2. Discussion of the Related Art

Fuel cells are power generators that produce electrical energy through electrochemical reactions of fuels with oxygen. Since they are not based on the Carnot cycle used in thermal power generation, their theoretical power generation efficiency is very high. Fuel cells can be used as power sources for small electrical/electronic devices, including portable devices, as well as for industrial, domestic, and transportation applications.

Types of fuel cells include polymer electrolyte membrane fuel cells (PEMFCs), phosphoric acid fuel cells (PAFCs), molten carbonate fuel cells (MCFCs), and solid oxide fuel cells (SOFCs). The working temperature of fuel cells and constituent materials vary depending on the electrolyte type used in a cell.

Depending upon how fuel is supplied to the anode, fuel cells are classified as external reformer types, where fuel is supplied to the anode after being converted into hydrogen-rich gas by a fuel reformer, or direct fuel supply or internal reformer types, where fuel in gaseous or liquid state is directly supplied to the anode.

An example of a direct fuel supply type cell is a direct methanol fuel cell (DMFC). In the DMFCs, an aqueous methanol solution is generally supplied to the anode. The DMFCs do not require an external reformer, they use fuel that is convenient to handle, and they have the highest potential as potable energy sources over other kinds of fuel cells.

Typical electrochemical reactions occurring in a DMFC include: fuel oxidation at the anode, and oxygen reduction into water through a reaction with hydrogen ions at the cathode.
Anode reaction: CH₃OH+H₂O→6 H⁺+6 e⁻+CO₂
Cathode Reaction: 1.5 O₂+6 H⁺+6 e⁻→3H₂O
Overall Reaction: CH₃OH+1.5 O₂→2 H₂O+CO₂

As apparent from the above reaction schemes, methanol reacts with water at the anode to produce one carbon dioxide molecule, six hydrogen ions, and six electrons. The produced hydrogen ions migrate to the cathode through an electrolyte membrane with hydrogen ion conductivity, which is interposed between the anode and the cathode. The migrated hydrogen ions react with oxygen and electrons, which are supplied via an external circuit at the cathode to produce water. Summarizing the overall reaction in the DMFC, water and carbon dioxide are produced through the reaction of methanol with oxygen. As a result, a substantial part of the energy equivalent to the heat of combustion of methanol is converted into electrical energy. In order to facilitate such reaction, the anode and the cathode include a catalyst.

Generally, the DMFC includes an electrolyte membrane for transporting hydrogen ions, which is interposed between an anode catalyst layer and a cathode catalyst layer.

An anode diffusion layer, which is located outside of the anode catalyst layer, acts as a path for transporting the aqueous methanol solution to the anode catalyst layer, as a path for discharging carbon dioxide produced at the anode catalyst layer, and as a conductor for transporting electrons produced at the anode catalyst layer. A cathode diffusion layer, which is located outside of the cathode catalyst layer, acts as a path for transporting oxygen or air to the cathode catalyst layer, as a path for discharging water produced at the cathode catalyst layer, and as a conductor for transporting electrons to the cathode catalyst layer.

An electroconductive bipolar plate or end plate, on a side of which a flow field for supplying the aqueous methanol solution and discharging carbon dioxide is formed, is disposed outside of the anode diffusion layer. An electroconductive bipolar plate or end plate, on a side of which a flow field for supplying oxygen and air and discharging water is formed, is disposed outside of the cathode diffusion layer.

In fuel cells using hydrogen gas or hydrogen containing gas as fuel, such as PEMFC and PAFC, both reactant and product in the anode are in gaseous state, and thus, the anode diffusion layer is not required to have complicated transporting property.

On the other hand, in DMFCs using aqueous methanol solution for fuel, the reactant and the product in the anode are liquid and gas, respectively, which requires the anode diffusion layer to have good liquid and gas transporting properties.

The DMFC cathode diffusion layer is required to have the same properties as the anode diffusion layer. Generally, the DMFCs operate at a temperature below the boiling point of water, for example, at about 80° C. Since the reactant and the product in the cathode are gas and liquid, respectively, the cathode diffusion layer also has to possess good liquid and gas transporting properties.

A conventional diffusion electrode for a fuel cell is generally manufactured by mixing carbon black with polytetrafluoroethylene (PTFE) and heat treating the mixture, as disclosed in U.S. Pat. No. 4,551,220.

U.S. Pat. No. 6,103,077 discloses a diffusion electrode having a two-layer structure. In the two-layer diffusion electrode, one layer is hydrophilic and the other layer is hydrophobic.

However, when the conventional diffusion layer is utilized in the DMFC, fuel in liquid state may flood the anode diffusion layer. As a result, the path for discharging gaseous product produced in the anode catalyst layer may be clogged. Accordingly, a lump of gaseous product may be present in the anode catalyst layer, thereby poisoning a catalyst in the anode catalyst layer. Moreover, gaseous product resulting from a side reaction has higher reactivity to the catalyst than fuel, allowing catalyst utilization efficiency to be lowered. Also, the lump of gas may prevent fuel from diffusing in the anode catalyst layer.

### SUMMARY OF THE INVENTION

Accordingly, the present invention is directed to a diffusion electrode for a fuel cell that substantially obviates one or more of the problems due to limitations and disadvantages of the related art.

The present invention provides a diffusion electrode for a fuel cell, having good polar liquid transporting property and gas transporting property.

The present invention also provides an electrode for a fuel cell, including a diffusion electrode having good polar liquid transporting property and gas transporting property.

The present invention also provides a fuel cell including a diffusion electrode having good polar liquid transporting property and gas transporting property.

Additional features of the invention will be set forth in the description which follows, and in part will be apparent from the description, or may be learned by practice of the invention.

The present invention discloses a diffusion electrode for a fuel cell, including hydrophobic porous agglomerates containing electroconductive particles and a hydrophobic binder resin, wherein the hydrophobic porous agglomerates form a three dimensional netlike structure; and hydrophilic porous agglomerates containing electroconductive particles, wherein the hydrophilic porous agglomerates form a three dimensional netlike structure filling spaces in the three dimensional netlike structure formed by the hydrophobic porous agglomerates.

This present invention also discloses an electrode for a fuel cell, including a catalyst layer and a diffusion electrode. The diffusion electrode further comprises hydrophobic porous agglomerates containing electroconductive particles and a hydrophobic binder resin, wherein the hydrophobic porous agglomerates form a three dimensional netlike structure; and hydrophilic porous agglomerates containing electroconductive particles, wherein the hydrophilic porous agglomerates form a three dimensional netlike structure filling space in the three dimensional netlike structure formed by the hydrophobic porous agglomerates.

This present invention also discloses a fuel cell including a cathode containing a catalyst layer and a diffusion layer, an anode containing a catalyst layer and a diffusion layer, and an electrolyte membrane interposed between the cathode and the anode, wherein at least one of the diffusion layer of the cathode and the diffusion layer of the anode is a diffusion electrode. The diffusion electrode is comprised of hydrophobic porous agglomerates containing electroconductive particles and a hydrophobic binder resin, wherein the hydrophobic porous agglomerates form a three dimensional netlike structure; and hydrophilic porous agglomerates containing electroconductive particles, wherein the hydrophilic porous agglomerates form a three dimensional netlike structure filling space in the three dimensional netlike structure formed by the hydrophobic porous agglomerates.

This present invention also discloses a method of manufacturing a diffusion electrode for a fuel cell, comprising mixing electroconductive particles, a hydrophobic binder resin and a solvent to form a product. The product is then dried and heat treated to prepare a composite powder of the electroconductive particles and the hydrophobic binder resin. The composite powder, electroconductive particles and a solvent are then mixed to prepare a diffusion electrode slurry. The diffusion electrode slurry is coated on a substrate, and then dried and heat treated.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a cross-sectional view of a diffusion electrode for a fuel cell according to an exemplary embodiment of the present invention.

FIG. 2 shows a material transporting procedure in a diffusion electrode of exemplary embodiment of the present invention.

FIG. 3 shows an exemplary embodiment of a method of manufacturing a diffusion electrode of the present invention.

FIG. 4 shows an SEM photograph of a cross section of a diffusion electrode manufactured in an Example of the present invention.

FIG. 5, FIG. 6, FIG. 7, and FIG. 8 show polarization curves of fuel cells obtained in First, Second, and Comparative Examples of the present invention.

### DETAILED DESCRIPTION OF THE INVENTION

Reference will now be made in detail to an embodiment of the present invention, example of which is illustrated in the accompanying drawings.

The diffusion electrode according to an exemplary embodiment of the present invention has different structure from a conventional diffusion electrode. In a direct methanol fuel cell (DMFC), an aqueous methanol liquid is supplied to an anode as fuel and CO₂ resulting from an electrochemical reaction in an anode catalyst layer is in a gaseous state. The diffusion electrode for the fuel cell of an exemplary embodiment of the present invention comprises divided hydrophilic paths for uniformly diffusing the aqueous methanol solution and hydrophobic paths for rapidly discharging CO₂. The hydrophobic paths are comprised of hydrophobic porous agglomerates containing electroconductive particles and a hydrophobic binder resin, wherein the hydrophobic porous agglomerates form a three dimensional netlike structure. The hydrophilic paths are comprised of hydrophilic porous agglomerates containing electroconductive particles, wherein the hydrophilic porous agglomerates form a three dimensional netlike structure filling space in the three dimensional netlike structure formed by the hydrophobic porous agglomerates.

The hydrophobic binder resin in the hydrophobic porous agglomerate may include polytetrafluoroethylene (PTFE), perfluoro(alkoxyalkane) (PFA) copolymer, fluorinated ethylene-propylene (FEP) copolymer, and other like substances.

When the content of the hydrophobic binder resin in the hydrophobic porous agglomerate is too low, hydrophobic property of the hydrophobic porous agglomerate is lowered, thus the hydrophobic porous agglomerate may soak in liquid fuel, which decreases its effectiveness as the gaseous product discharging path. On the other hand, when the content is too high, the content of the electroconductive particles in the hydrophobic porous agglomerate is greatly decreased. Accordingly, electroconductivity of the diffusion electrode decreases, and it is difficult to form a microporous path. Consequently, the content of the hydrophobic binder resin in the hydrophobic porous agglomerate may be in the range of about 20 to about 80% by weight.

The electroconductive particles in the hydrophobic porous agglomerate may include spherical or needle-shaped carbon powder, graphite powder, and other like substances.

When an average particle diameter of the electroconductive particles in the hydrophobic porous agglomerate is too small, it is difficult to form the porous path. When their average diameter is too large, a resulting pore is also large, thereby causing loss of the catalyst layer formed on the diffusion electrode. Consequently, the average particle diameter of the electroconductive particles in the hydrophobic porous agglomerate may be in the range of about 30 to about 300 nm.

The electroconductive particles in the hydrophilic porous agglomerate may include spherical or needle-shaped carbon powder, graphite powder, and other like substances.

When the average particle diameter of the electroconductive particles in the hydrophilic porous agglomerate is too small, it is difficult to form the porous path. On the other hand, when their average diameter is too large, a resulting pore is also large, thereby causing loss of the catalyst layer formed on the diffusion electrode. Consequently, the average particle diameter of the electroconductive particle in the hydrophilic porous agglomerate may be in the range of about 30 to about 300 nm.

As described above, the diffusion electrode of an exemplary embodiment of the present invention includes a hydrophobic porous agglomerate and a hydrophilic porous agglomerate. Both the hydrophobic porous agglomerate and the hydrophilic porous agglomerate form irregular netlike networks that entangle complementarily. Although both agglomerates form netlike networks, the agglomerates form separate paths for transporting the liquid reactant and gaseous product in a direction of the thickness of the diffusion electrode.

A weight ratio of the hydrophobic porous agglomerate to the hydrophilic porous agglomerate may be appropriately determined to have both liquid reactant transporting ability and gaseous product transporting ability.

In view of this, the weight ratio of the hydrophobic porous agglomerate to the hydrophilic porous agglomerate in the diffusion electrode of an exemplary embodiment of the present invention may be in the range of about 10:90 to about 90:10.

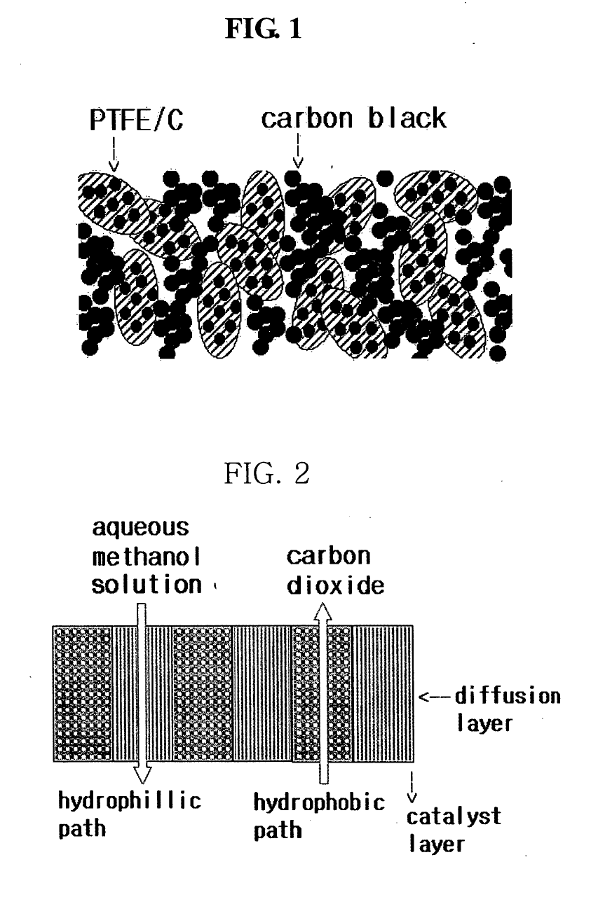

FIG. 1 is a cross-sectional view of a diffusion electrode for a fuel cell of an exemplary embodiment of the present invention. Referring to FIG. 1, the hydrophilic path composed of mainly carbon is arranged in a direction of the thickness of the diffusion electrode. The hydrophobic path adjacent to the hydrophilic path, composed of mainly carbon and PTFE, is also arranged in a direction of the thickness of the diffusion electrode. These structures are arranged throughout the diffusion electrode. The hydrophilic and hydrophobic paths are porous.

When the diffusion electrode is utilized in a DMFC, the aqueous methanol solution used as fuel is supplied to the anode catalyst layer by rapid diffusion via the hydrophilic path of the anode diffusion layer. The aqueous methanol solution mainly diffuses via the hydrophilic path, and the pores of the adjacent hydrophobic path remain open. The aqueous methanol solution reaches the anode catalyst layer and causes an electrochemical reaction with aid of a catalyst. Hydrogen ions produced by the electrochemical reaction pass through the catalyst layer and are transported to the cathode via a cluster of electrolyte.

In the anode catalyst layer, in addition to CO₂, CO, which may poison the catalyst, may be produced by a side reaction. However, when the diffusion electrode of the present invention is utilized, CO₂ and CO may be rapidly discharged outside of the fuel cell through the hydrophobic path of the anode diffusion layer, thereby keeping the catalyst of the anode catalyst layer active. While the fuel cell operates, the aqueous methanol solution may not permeate the hydrophobic path, so that the open pores continuously connected to one another are stably ensured. Resulting gas may be easily discharged outside of the fuel cell through the ensured pores of the hydrophobic path. As described above, since migrations of the aqueous methanol solution and the resulting gas are rapidly performed through separate paths, the electrochemical reaction in the catalyst layer may rapidly occur without the influence of the reactant and the product.

Since electrons may migrate through a continuous hydrophilic carbon path, electrons produced in the catalyst layer may be easily transported to an external circuit.

FIG. 2 illustrates a material transporting procedure in a diffusion electrode of an exemplary embodiment of the present invention. As described above, fuel is supplied via the hydrophilic path composed of carbon, and gaseous product is discharged via the hydrophobic path composed of PTFE/C.

A diffusion electrode for a fuel cell of an exemplary embodiment of the present invention may be manufactured by the following method. Electroconductive particles, a hydrophobic binder resin and a solvent are mixed and dried. The dried product is heat treated to prepare composite powder of the electroconductive particles and the hydrophobic binder resin. Next, the composite powder, electroconductive particles and a solvent are mixed to prepare a diffusion electrode slurry. Finally, the slurry is coated on a substrate and dried and heat treated.

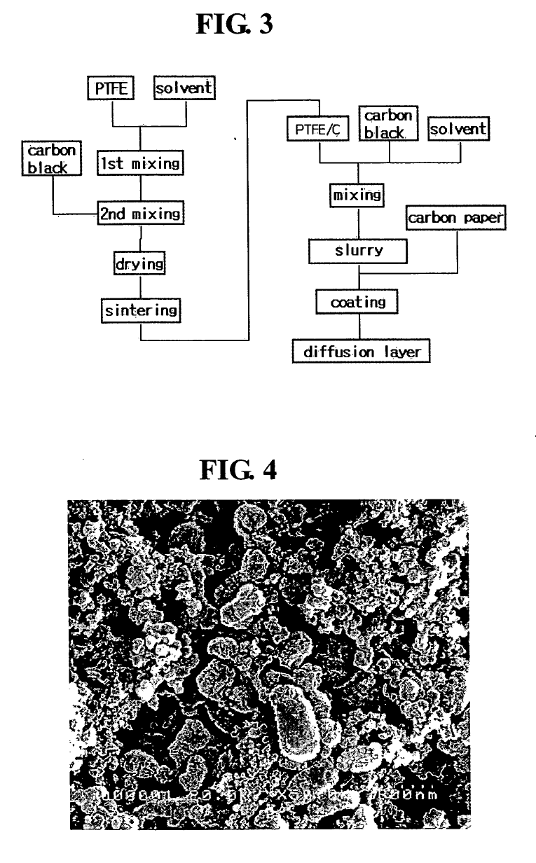

FIG. 3 is a schematic view of an exemplary embodiment of a method of manufacturing the diffusion electrode of the present invention. Initially, a suspension of the hydrophobic binder resin, such as PTFE, and a solvent are first mixed. Examples of the solvent include water, an alcoholic solvent, and a mixture thereof. Specific examples of the alcoholic solvent include isopropylalcohol, etc. The first mixing may be performed using a mixer with low rotational frequency. Next, a second mixing is performed by adding electroconductive particles, such as carbon black, to the mixture and by stirring the mixture. The stirrer used in the second mixing may be a stirrer having higher rotational frequency than the stirrer used in the first mixing. PTFE and carbon black are uniformly mixed by thoroughly stirring, and the mixture is then dried in an oven at about 60 to about 100° C. The dried substance is sintered at about 330 to about 370° C., thereby forming composite powder of the electroconductive particles and the hydrophobic binder resin, such as PTFE/C composite powder.

In order to prepare the diffusion electrode slurry, PTFE/C composite powder, carbon powder and an alcoholic solvent are first uniformly mixed using a mixer. Isopropylalcohol may be used as the alcoholic solvent.

The obtained diffusion electrode slurry is then coated on a substrate, such as a carbon paper, and dried and heat treated (sintering) to complete the diffusion electrode. Examples of a coating method include painting, spraying, etc. The diffusion electrode slurry coated on the substrate is dried at a temperature of about 60 to about 100° C. The solvent in the coated slurry is removed through this drying process, and then, the dried diffusion electrode is sintered. The sintering process may be performed at a temperature of about 330 to about 370° C.

In a method of manufacturing a diffusion electrode in accordance with an exemplary embodiment of the present invention, it is noted that the heat treated composite powder including the hydrophobic polymer and the electroconductive particles is first prepared, and the slurry including the heat treated composite powder and the electroconductive particles is used to form the diffusion electrode for the fuel cell.

The present invention also dislcoses an electrode for a fuel cell, including a catalyst layer and the above diffusion electrode.

The electrode of the present invention may be applied to the anode and the cathode in various types of fuel cells, including PAFC, PEMFC, and particularly DMFC.

The anode and the cathode may be manufactured using a known conventional method, therefore, its detailed description is omitted. The diffusion electrode is formed according to the above-described method of the present invention.

The present invention also provides a fuel cell including a cathode containing a catalyst layer and a diffusion layer, an anode containing a catalyst layer and a diffusion layer, and an electrolyte membrane interposed between the cathode and the anode, wherein at least one of the diffusion layer of the cathode and the diffusion layer of the anode is the diffusion electrode according to the present invention.

The fuel cell of the present invention can be applied to, for example, PAFC, PEMFC, DMFC, and in particular DMFC.

The fuel cell may be manufactured using a conventional method known in various literatures, therefore, its detailed description is omitted. The diffusion electrode is formed according to the above-described method of the present invention.

The present invention will be described in greater detail with reference to the following examples. The following examples are for illustrative purposes and are not intended to limit the scope of the invention.

### EXAMPLE 1

### Manufacturing of a Diffusion Electrode

1.67 g of PTFE suspension (60% by weight of aqueous dispersion) was added to a mixture of 8.35 g of isopropylalcohol (IPA) and 8.35 g of ultrapure water and the obtained mixture was uniformly mixed using a stirrer to prepare a diluted PTFE suspension. 1 g of carbon black (Vulcan XC-72R) was mixed with 15 g of IPA, and the obtained mixture was stirred using an ultrasonic homogenizer for 20 minutes to prepare a carbon black dispersion.

The diluted PTFE suspension and the carbon black dispersion were then mixed and stirred for 10 minutes. After removing some solvent from the mixture under vacuum, the remaining mixture was dried in an oven at 80° C. for 2 hours to completely remove any remaining solvent. The mixture of PTFE and carbon black was then sintered in a furnace under an inactive atmosphere for 20 minutes to obtain PTFE/C composite powder.

1 g of the PTFE/C composite powder was then dispersed in 20 g of IPA, and 2 g of carbon black (Vulcan XC-72R) was dispersed in 15 g of IPA. Next, these dispersions were mixed using an ultrasonic homogenizer to obtain a diffusion electrode slurry.

The diffusion electrode slurry was then coated on a carbon paper by spraying, and the coated carbon paper was dried in an oven at 80° C. for 2 hours to obtain a diffusion electrode. The amount of carbon black (Vulcan XC-72R) in the diffusion electrode was 0.3 mg/cm².

FIG. 4 is a SEM photograph of a cross section of the diffusion electrode prepared in this Example. In FIG. 4, larger particles shown in a central portion are the PTFE/C composite powders in which PTFE and carbon black are combined. Smaller particles in a peripheral portion are carbon black. As is apparent from FIG. 4, a structure of separate hydrophobic path and hydrophilic path networks is formed.

### Manufacturing of an Anode

0.24 g of Pt—Ru powder and 0.2 g of distilled water were mixed in a stirrer such that the Pt—Ru powder was soaked in distilled water. 3.6 g of IPA was added to the mixture and stirred with an ultrasonic homogenizer for about 20 minutes, thereby obtaining an anode catalyst layer forming slurry. The slurry was sprayed on the previously prepared diffusion electrode and dried in an oven at 80° C. for about 2 hours to remove the remaining solvent, thereby obtaining an anode. The loading amount of Pt—Ru catalyst of the anode was 4 mg/cm².

### Manufacturing of a Cathode

0.24 g of Pt powder and 0.3 g of distilled water were mixed such that Pt powder was soaked in distilled water. The same process used to form the anode was performed to obtain the cathode. The loading amount of Pt catalyst of the cathode was 4 mg/cm².

### Manufacturing of a Fuel Cell

Nafion 115 was used as an electrolyte membrane. The above anode, the above cathode, and Nafion 115 membrane were hot pressed to obtain a membrane & electrode assembly (MEA). The hot pressing was performed at 125° C. under a pressure of 5 ton for 3 minutes.

### EXAMPLE 2

In Example 1, a weight ratio of the PTFE/C composite powder and the carbon black was 1:2. Thus, the hydrophilic path composed of carbon black was relatively broadly spread, enabling fuel to be more smoothly supplied.

However, in this Example, a weight ratio of the PTFE/C composite powder and the carbon black was 1:1, (i.e., the amount of carbon black was reduced). Accordingly, the hydrophobic path composed of PTFE/C composite powder was more broadly spread than in Example 1, thereby allowing gaseous product to be more smoothly discharged. Other processes were performed in the same manner as in Example 1.

### Comparative Example

1 g of carbon black (Vulcan XC-72R) was mixed with 30 g of IPA and stirred for 20 minutes using an ultrasonic homogenizer. Then, 1.67 g of an PTFE suspension (60% by weight of aqueous dispersion) was mixed with the stirred carbon black dispersion and stirred for 10 minutes to prepare a diffusion electrode slurry, which was coated on a carbon paper by spraying under the same conditions and utilizing the same carbon paper of Example 1. The coated diffusion electrode was dried in an oven at 80° C. for 2 hours to completely remove the solvent, and then sintered in a furnace at 350° C. for about 20 minutes, thereby forming a comparative anode diffusion electrode. Other processes including coating a catalyst layer were performed in the same manner as in Example 1 to obtain a diffusion electrode, an electrode, and a fuel cell.

### Evaluation Result

In the fuel cells of Example 1 and the Comparative Example, a 2M aqueous methanol solution was used to supply fuel to the anode at a flow rate of about 3 times with respect to stoichiometric amount of fuel required in a fuel cell. Air in atmosphere was supplied as an oxidant to the cathode at a flow rate of about 3 times with respect to stoichiometric amount. An operating temperature was in the range of 30 to 50° C.

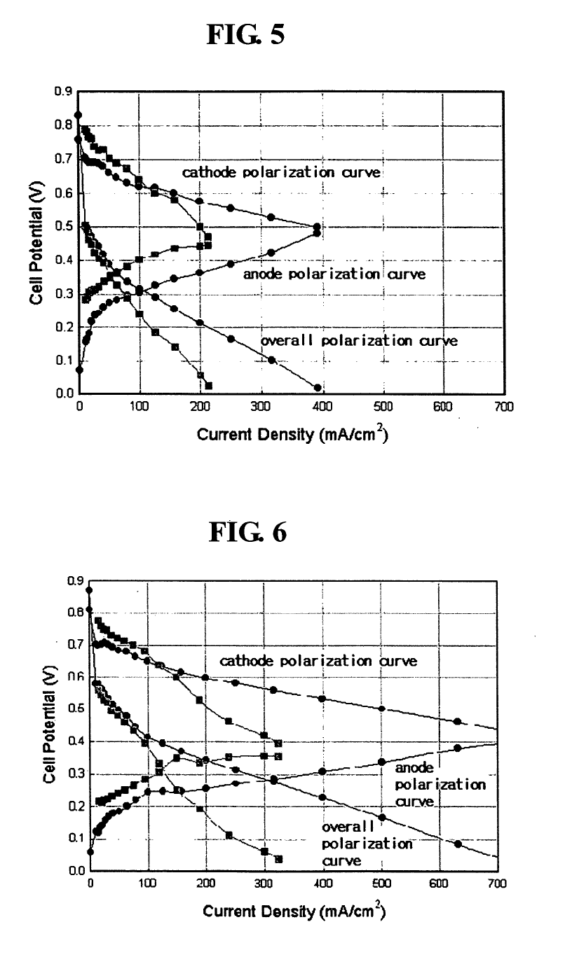

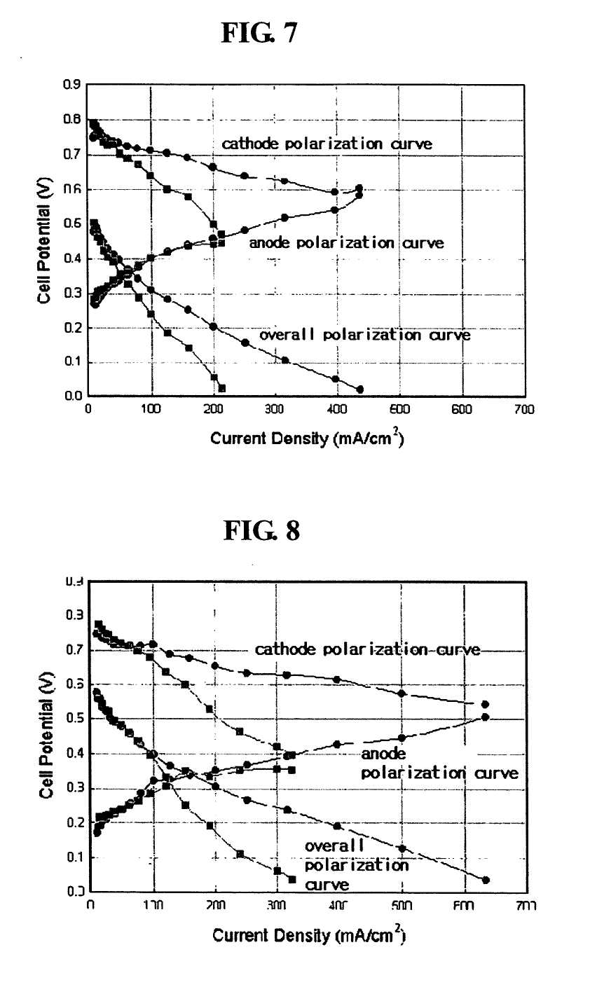

FIG. 5 is a graph of polarization curves of the fuel cells of Example 1 and the Comparative Example. The square/solid line represents the performance of the fuel cell of the Comparative Example, and the circle/solid line represents the performance of the fuel cell of Example 1. The operating conditions were 30° C. and atmospheric pressure. Referring to the anode polarization curve, it is apparent that the fuel cell of Example 1 had better performance than that of the Comparative Example. Fuel supplied via the hydrophilic path underwent electrochemical reaction with the anode catalyst. At this time, CO₂ produced as a side product was rapidly discharged via the hydrophobic path, thereby retaining a good utilization efficiency of the anode catalyst. Accordingly, although the amount of current increased, the voltage minimally decreased. Also, the amount of fuel supplied was limited due to the hydrophobic path, and most of the fuel supplied to the catalyst layer was used in the electrochemical reaction, thereby suppressing cross-over of methanol through the electrolyte membrane. Accordingly, the poisoning of the cathode catalyst by methanol was prevented and mixing potential formed by the reaction of methanol in the cathode decreased, resulting in lower gradient of the cathode polarization curve. As a result, the gradient of the overall polarization curve also lowered, leading to improved performance.

Referring to the overall polarization curves of FIG. 5, the difference of current density at a cell potential of 0.4 V in fuel cells of Example 1 and the Comparative Example was small. However, at a cell potential of 0.3 V, the fuel cell of Example 1 had increased current density about 50% higher than the current density of the fuel cell of the Comparative Example. Also, the gradient of the overall polarization curve of the fuel cell of Example 1 at a cell potential of 0.4 V or less was much lower than that of the Comparative Example. FIG. 5 shows that in the fuel cell of Example 1, supplying of fuel and discharging of product rapidly occur, and thus, overvoltage due to material transporting is not high. In other words, the diffusion electrode efficiently supplies reactant and discharges product.

In the fuel cells of Example 1 and the Comparative Example, a 2M aqueous methanol solution was supplied as fuel to the anode at a flow rate of 3 times with respect to stoichiometric amount. Air was supplied as an oxidant to the cathode at a flow rate of 3 times with respect to stoichiometric amount. An operating temperature was 50° C. Polarization curves of the fuel cells under these conditions are shown in FIG. 6.

Referring to FIG. 6, the effect of the diffusion electrode of Example 1 was enhanced by raising the temperature, and the performance of the fuel cell of Example 1 was improved at least 2 times based on that of the fuel cell of the Comparative Example. Referring to the overall polarization curves, at a cell potential of 0.3 V, the fuel cell of Example 1 had a current density of about 120 mA/cm² in FIG. 5. On the other hand, in FIG. 6, at the same cell potential of 0.3 V, the current density of the fuel cell of Example 1 was about 280 mA/cm², which is an increase of about 230%. However, with the fuel cell of the Comparative Example, the current density increased from about 90 mA/cm² in FIG. 5 to about 120 mA/cm² in FIG. 6, which is an increase of about 30%. This is because as the amount of current increased, the amount of methanol supplied also increased, indicating that more methanol was supplied in FIG. 6 than in FIG. 5. In the fuel cell of the Comparative Example, the diffusion electrode did not effectively diffuse the increased methanol. Conversely, in the fuel cell of Example 1, the diffusion electrode effectively diffused methanol although the amount of methanol increased. The diffusion electrode of the fuel cell of Example 1 also effectively operated in a range of the cell potential of 0.2 V or lower, allowing the amount of current to be increased at least 2 times based on that of the fuel cell of the Comparative Example.

In the fuel cells obtained in Example 2 and the Comparative Example, a 2M aqueous methanol solution was supplied as fuel to the anode at a flow rate of 3 times with respect to stoichiometric amount. Air was supplied as an oxidant to the cathode at a flow rate of 3 times with respect to stoichiometric amount. Operating temperatures were 30° C. and 50° C. Polarization curves of the fuel cells are shown in FIGS. 7 (30° C.) and 8 (50° C.). In FIGS. 7 and 8, like FIGS. 5 and 6, the square/solid line represents the performance of the fuel cell of the Comparative Example, and the circle/solid line represents the performance of the fuel cell of Example 2.

As apparent in FIGS. 7 and 8, the performance of the fuel cell of Example 2 increased more than that of the fuel cell of the Comparative Example. Also, the effect by temperature similar to Example 1 was obtained.

In the diffusion electrode of the present invention, liquid fuel supply paths and gaseous product discharge paths are separately located, and each path is microporous. Each path is vertically and continuously connected in the diffusion electrode between the catalyst layer and the outer substrate. Thus, if the diffusion electrode is applied to the DMFC, the following effects may be obtained.

First, the aqueous methanol solution as fuel may be continuously and uniformly supplied to the catalyst layer. Since fuel is transported via micropores, a large amount of fuel may be prevented from being supplied to the catalyst layer at a any given time, thereby improving fuel and catalyst reaction efficiency.

Second, CO₂ may be rapidly discharged via the hydrophobic path since the hydrophobic path may not be soaked in liquid fuel.

Third, cross-over of methanol may be suppressed since most of the methanol supplied via a microstructure reacts with the catalyst.

Fourth, electroconductivity may be improved. Electrons created by the electrochemical reaction may easily migrate to a counter electrode via an external circuit through the continuous microstructure composed of carbon powder. In a conventional diffusion electrode, carbon powder and PTFE are mixed, and thus, carbon powder may not be continuously present. As a result, electron transporting may be interrupted. However, in the diffusion electrode of the present invention, this problem is resolved, thereby improving electroconductivity.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A diffusion electrode for a fuel cell, comprising:
hydrophobic porous agglomerates containing electroconductive particles and a hydrophobic binder resin, wherein the hydrophobic porous agglomerates form a three dimensional netlike structure; and
hydrophilic porous agglomerates containing electroconductive particles, wherein the hydrophilic porous agglomerates form a three dimensional netlike structure filling space in the three dimensional netlike structure formed by the hydrophobic porous agglomerates.

2. The diffusion electrode of claim 1, wherein the hydrophobic binder resin is polytetrafluoroethylene (PTFE), perfluoro(alkoxyalkane) (PFA) copolymer, fluorinated ethylene-propylene (FEP) copolymer, or a mixture thereof.

3. The diffusion electrode of claim 1, wherein a content of the hydrophobic binder resin is in a range of about 20 to about 80% by weight.

4. The diffusion electrode of claim 1, wherein the electroconductive particles in the hydrophobic porous agglomerate are spherical or needle-shaped carbon powder.

5. The diffusion electrode of claim 4, wherein an average particle diameter of the carbon powder is in a range of about 30 to about 300 nm.

6. The diffusion electrode of claim 1, wherein the electroconductive particles in the hydrophilic porous agglomerate are spherical or needle-shaped carbon powder.

7. The diffusion electrode of claim 6, wherein an average particle diameter of the carbon powder is in a range of about 30 to about 300 nm.

8. The diffusion electrode of claim 1, wherein a weight ratio of the hydrophobic porous agglomerate to the hydrophilic porous agglomerate is in a range of about 10:90 to about 90:10.

9. An electrode for a fuel cell, comprising:
a catalyst layer; and
a diffusion electrode further comprising:
hydrophobic porous agglomerates containing electroconductive particles and a hydrophobic binder resin, wherein the hydrophobic porous agglomerates form a three dimensional netlike structure; and
hydrophilic porous agglomerates containing electroconductive particles, wherein the hydrophilic porous agglomerates form a three dimensional netlike structure filling space in the three dimensional netlike structure formed by the hydrophobic porous agglomerates.

10. A fuel cell, comprising:
a cathode containing a catalyst layer and a diffusion layer;
an anode containing a catalyst layer and a diffusion layer;
and an electrolyte membrane interposed between the cathode and the anode,
wherein at least one of the diffusion layer of the cathode and the diffusion layer of the anode is a diffusion electrode further comprising:
hydrophobic porous agglomerates containing electroconductive particles and a hydrophobic binder resin, wherein the hydrophobic porous agglomerates form a three dimensional netlike structure; and
hydrophilic porous agglomerates containing electroconductive particles, wherein the hydrophilic porous agglomerates form a three dimensional netlike structure filling space in the three dimensional netlike structure formed by the hydrophobic porous agglomerates.

11. A method for manufacturing a diffusion electrode for a fuel cell, comprising:
mixing electroconductive particles, a hydrophobic binder resin and a solvent to form a product;
drying the product, then heat treating the product to prepare a composite powder of the electroconductive particles and the hydrophobic binder resin;
mixing the composite powder, electroconductive particles and a solvent to prepare a diffusion electrode slurry; and
coating the diffusion electrode slurry on a substrate, and then drying and heat treating the coated diffusion electrode slurry.
